(19) United States
(12) Patent Application Publication
(10) Pub. No.: US 2023/0086811 A1
(43) Pub. Date: Mar. 23, 2023

(54) TOWER ARRAY

(71) Applicant: Airloom Energy, Inc., Laramie, WY (US)

(72) Inventor: Robert LUMLEY, Laramie, WY (US)

(73) Assignee: Airloom Energy, Inc., Laramie, WY (US)

(21) Appl. No.: 17/909,157

(22) PCT Filed: Mar. 5, 2021
(86) PCT No.: PCT/US2021/021242

§ 371 Date: Sep. 2, 2022

Related U.S. Application Data
(60) Provisional application No. 62/985,748, filed on Mar. 5, 2020.

(51) Int. Cl. F03D 5/02; F03D 9/25; F03D 5/04

(52) U.S. Cl. CPC F03D 5/02; F03D 9/25; F03D 5/04

(57) ABSTRACT

In some embodiments, an apparatus includes at least two towers arranged in each of a first direction and a second direction, each tower having a first end above a second end in a third direction. In some embodiments, the apparatus includes a bridling system connecting each of the towers to other towers, the bridling system connected to eachtower above the second end of the respective tower and balancing forces on each tower in the first and second directions.

### CROSS-REFERENCE TO RELATED APPLICATIONS

This application claims benefit of U.S. Provisional Application No. 62/985,748, filed Mar. 5, 2020, the entire disclosure of which is herein incorporated by reference for all purposes.

### FIELD OF INVENTION

This disclosure generally relates to power harvesting systems. More specifically, this disclosure relates to methods and apparatuses configured to harvest power from fluid motion.

### BACKGROUND OF THE INVENTION

There are many advantages to harvesting energy by converting mechanical energy generated by fluid motion (e.g., wind) into stored energy (e.g., electricity). Wind is a renewable resource and, unlike solar energy, is available anywhere in the world and at any time of the year. Some energy apparatuses are configured to float, for example, on water. However, known systems are not mechanically stable in different environmental conditions (e.g., the apparatus is mechanically stable enough to harvest energy in stormy conditions), and energy harvesting opportunities are reduced.

### SUMMARY OF THE INVENTION

In some embodiments, an apparatus includes at least two towers arranged in each of a first direction and a second direction, each tower having a first end above a second end in a third direction. In some embodiments, the apparatus includes a bridling system connecting each of the towers to other towers, the bridling system connected to each tower above the second end of the respective tower and balancing forces on each tower in the first and second directions. The disclosed structure may allow the apparatus to be advantageously scaled for different sizes and different energy harvesting needs in a cost effective and mechanically stable manner.

In some embodiments, an apparatus includes: a plurality of towers comprising at least two towers arranged in each of a first direction and a second direction, each tower having a first end above a second end in a third direction; and a bridling system connecting each of the plurality of towers to other towers of the plurality of towers, the bridling system connected to each tower above the second end of the respective tower and balancing forces on each tower in the first and second directions.

In some embodiments, the apparatus further includes: a track having first and second sections coupled to towers of the plurality of towers; a terminal connecting the first and second sections; an airfoil moveable in opposite directions when alternately coupled to the first section and second section; and a power generator to harvest power from a fluid through the movement of the airfoil.

In some embodiments, the apparatus further includes a plurality of buoyant devices, each connected at the second end of a respective one of the plurality of towers.

In some embodiments, the apparatus is configured such that the buoyant devices are positioned below a water-air interface when the bridling system balances the forces on the towers.

In some embodiments, the bridling system is connected to each tower at two points above the second end of the respective tower.

In some embodiments, the apparatus is configured such that, when forces on the apparatus are balanced, a first part of the bridling system is positioned above the water-air interface and a second part of the bridling system is positioned below the water-air interface.

In some embodiments, the apparatus further includes an anchor positioned below a water-air interface, wherein each outer tower of the plurality of towers is coupled above the water-air interface to the anchor.

In some embodiments, the apparatus further includes an anchor, wherein each outer tower of the plurality of towers is coupled to the anchor.

In some embodiments, the anchor includes multiple anchor points, each connected to two other anchor points by an anchor bridle, and the each outer tower of the plurality of towers is connected to the anchor bridle.

In some embodiments, the bridling system is connected to each tower at two points on the respective tower.

In some embodiments, a method includes: providing a plurality of towers; arranging at least two towers in each of a first direction and a second direction, each tower having a first end above a second end in a third direction; and connecting a bridling system from each of the plurality of towers to other towers of the plurality of towers, the bridling system connected to each tower above the second end of the respective tower and balancing forces on each tower in the first and second directions.

In some embodiments, the method further includes: providing a track having first and second sections coupled to the towers of the plurality of towers; connecting a terminal to the first and second sections; coupling an airfoil to the track, wherein the airfoil is moveable in opposite directions when alternately coupled to the first section and second section; and harvesting power from a fluid through the movement of the airfoil.

In some embodiments, the method further includes: connecting a plurality of buoyant devices at the second end of each of a respective one of the plurality of towers.

In some embodiments, the method further includes positioning the buoyant devices below a water-air interface.

In some embodiments, the method further includes connecting the bridling system to each tower at two points above the second end of the respective tower.

In some embodiments, the method further includes positioning a first part of the bridling system above the water-air interface and a second part of the bridling system below the water-air interface.

In some embodiments, the method further includes: positioning an anchor below the water-air interface; and coupling outer towers of the plurality of towers above the water-air interface to the anchor.

In some embodiments, the method further includes: positioning an anchor; and coupling outer towers of the plurality of towers to the anchor.

In some embodiments, the method further includes: connecting multiple anchor points to two other anchor points by an anchor bridle; and connecting the each outer tower of the plurality of towers to the anchor bridle.

In some embodiments, the method further includes connecting the bridling system to each tower at two points on the respective tower.

### BRIEF DESCRIPTION OF THE DRAWINGS

FIGS. 1A and 1B illustrate an exemplary apparatus, according to embodiments of the disclosure.

FIG. 2 illustrates an exemplary method of an exemplary apparatus, according to embodiments of the disclosure.

### DETAILED DESCRIPTION OF THE INVENTION

In some embodiments, an apparatus includes at least two towers arranged in each of a first direction and a second direction, each tower having a first end above a second end in a third direction. In some embodiments, the apparatus includes a bridling system connecting each of the towers to other towers, the bridling system connected to each tower above the second end of the respective tower and balancing forces on each tower in the first and second directions. The disclosed structure may allow the apparatus to be advantageously scaled for different sizes and different energy harvesting needs in a cost effective and mechanically stable manner.

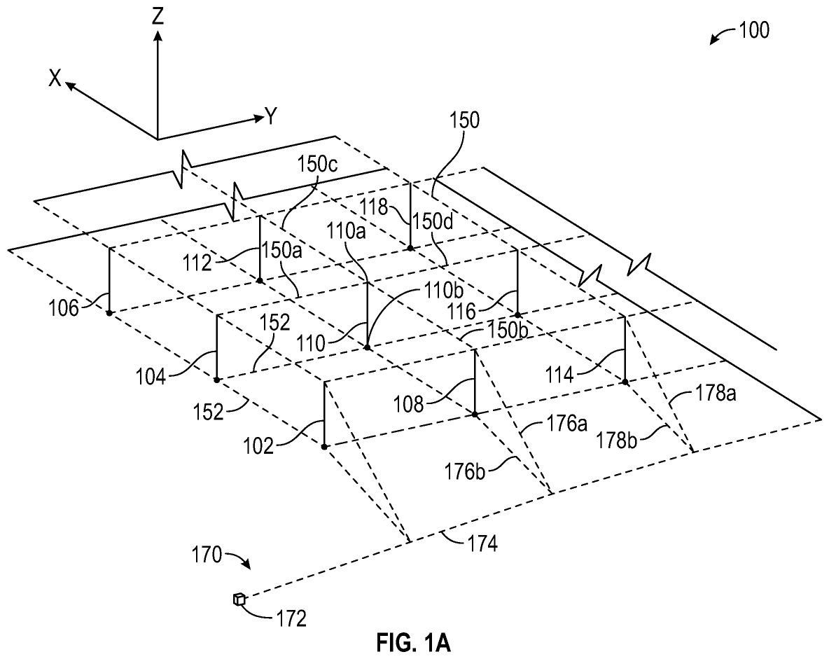

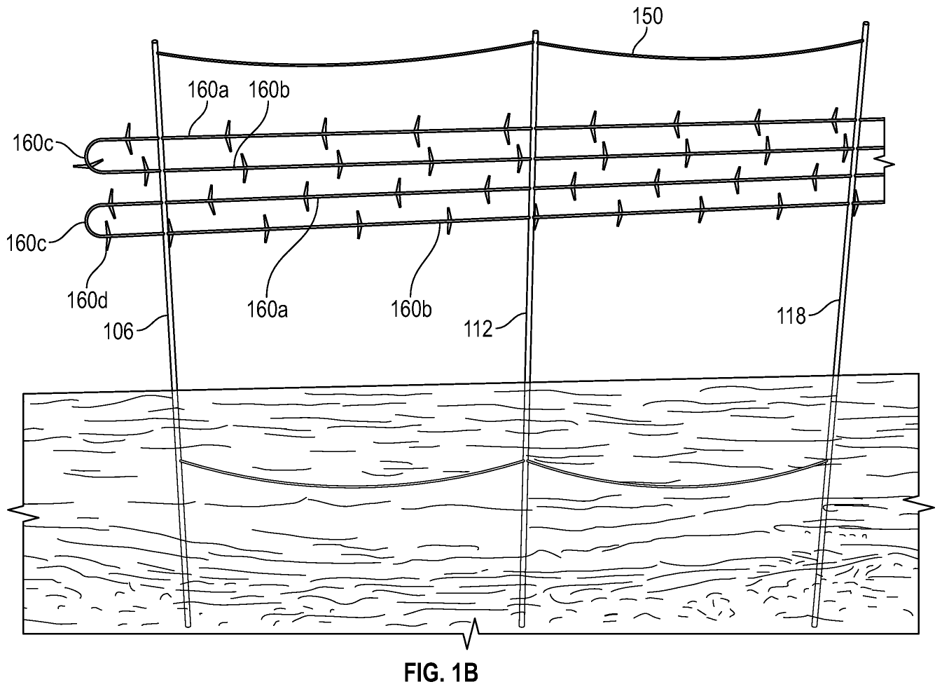

FIG. 1 illustrates apparatus 100 including towers (e.g., towers 102-118). In some embodiments, for example, towers 108, 110, and 112 are arranged in a direction parallel to the X-axis, and towers 104, 110, and 116 are arranged in a direction parallel to the Y-axis. Each tower has a first end above a second end in a direction parallel to the Z-axis. For example, tower 110 has first end 110a and second end 110b. It will be appreciated by those skilled in the art that the coordinate system X-Y-Z is given for illustration only and is not limiting.

In some embodiments, apparatus 100 includes bridling system 150 configured to interconnect the towers and balance X-Y direction forces on the towers. Using the bridling system 150's connections to tower 110 as an example, as illustrated, the bridling system connects tower 110 to towers 104 (through bridle 150a of the bridling system 150), 108 (through bridle 150b of the bridling system 150), 112 (through bridle 150c of the bridling system 150), and 116 (through bridle 150d of the bridling system 150). In some embodiments, a different number of towers may be connected (e.g., to create different angles (e.g., 120 degrees) between bridles, instead of the 90 degrees shown throughout apparatus 100). In some embodiments, each tower is connected to bridling system 150 at the respective first end (above the respective second end in the Z direction). For example, the bridling system 150 connects tower 110 to towers 104, 108, 112, and 116 at first end 110a. In some embodiments, a separate between adjacent towers is 2.5 to 3 times a tower height. In some embodiments, bridling system 150 is connected at a position other than the first end (e.g., at the second end, at multiple positions along the towers). In some embodiments, the bridling system 150 connects to each tower above the second end of the respective tower and balancing forces on each tower in the first and second directions. For example, a tower has at least two bridling points. One bridling point is near the bottom of the tower, above the second end, underwater (e.g., as illustrated in FIG. 1B), and under a flotation barge (not shown (e.g., for clarity)). Another bridling point is near the top of the tower. In some embodiments, the apparatus illustrated in FIG. 1B is anchored to sea floor anchor points (e.g., as described with respect to FIG. 1A).

In some embodiments, a bridle sags, and the sag is 5%-10% of tower spacing. In some embodiments, the sag is 5%-25% of tower spacing. In some embodiments, the sag is more apparent in an upper bridle rather than a lower bridle, as the lower line would have reduced sag due to the buoyancy of the lines themselves. Using bridle 150b as an example, in some embodiments, the apparatus 100 has the following parameters: tower heights between the bridle is 50 meters; separation between the towers is 1.5 to 5 times the tower height; the sag is 10%; a wingspan of an airfoil (described with respect to FIG. 1B) is 6 meters; two tracks (described with respect to FIG. 1B) (four wing heights); inter-row separation of ten diameters; the sag between two towers within a row is 15 meters; bottom of the sag is 35 meters above water-line. For two towers in different rows: row separation is 10 diameters×4 wings×6 meters=240 meters, the sag is 24 meters, and the bottom of the sag is 26 meters above the water-line. In some embodiments, the apparatus 100 includes an auxiliary tie down rope between each row of towers (e.g., when a sag between rows may be too great, given a rigidity requirement).

In some embodiments, as illustrated in more detail in FIG. 1B, apparatus 100 includes a track having first section 160a above second section 160b and connected by terminal 160c. It is understood that some elements of the apparatus 100 are not shown in FIG. 1B for clarity. It is also understood that in some embodiments, the apparatus 100 illustrated in FIG. 1A includes at least one track, but is not shown in FIG. 1A for clarity. In some embodiments, the tracks are supported by respective towers of the apparatus (e.g., the tracks are coupled to the respective towers). In some embodiments, a terminal 160c is 5 meters from a nearest tower (e.g., terminal 160c is 5 meters from tower 106). In some embodiments, the apparatus 100 includes a suspension rope to advantageously keep the tracks from potentially bending. In some embodiments, the track comprises an oval-like shaped structure, and the oval-like shaped structure comprise two rails (e.g., first section 160a and second section 160b).

For example, as illustrated, two tracks are supported by towers 106, 112, and 118. It is understood that the illustration of the tracks in FIG. 1B and references to the tracks in FIG. 1A are exemplary, and that the apparatus 100 may include different number or arrangement of tracks supported by different towers of the apparatus at different locations of the apparatus. In some embodiments, an airfoil 160d moves in opposite directions when alternately coupled to the first section and second section. In some embodiments, a wingspan of an airfoil 160d is between 3 meters and 20 meters. In some embodiments, the tracks are configured to capture power from water, and the airfoil 160d is a hydrofoil instead. In some embodiments, apparatus 100 includes a power generator (not shown) to harvest power from a fluid (e.g., wind, water) through the movement of the airfoil. Exemplary systems and methods for power generation are disclosed in U.S. Pat. No. 9,651,027 and WIPO Publication No. WO 2017/165442, incorporated by reference herein in their entireties for all purposes. Although embodiments herein are primarily described with respect to airfoils moving on tracks, other power generation mechanisms could be used, such as horizontal axis wind turbines, for example. Further, non-power generation systems can also utilize the tower and bridling systems described herein. In some embodiments, as illustrated, a plurality of airfoils is coupled to a track.

In some embodiments, apparatus 100 includes anchor 170. In some embodiments, bridling system 150 comprises anchor 170. In some embodiments, outer towers of the plurality of towers (e.g., towers closest to an edge of the apparatus 100) are coupled to anchor 170. For example, in apparatus 100, towers 108 and 114 are coupled to anchor 170. Other outer towers of apparatus may be coupled to other anchors (not shown).

As shown in FIG. 1, in some embodiments, anchor 170 includes fixed attachment 172 coupled to an exterior surface, such as the ground or a sea bed. Fixed Attachment 172 is illustrated as positioned below the second end of the towers, but one of skill in the art will recognize that fixed attachment 172 can be attached at a different level, such as the same level as the second end of the towers, for example.

In some embodiments, each outer tower is directly anchored to a fixed attachment point (e.g., a bridle connected at the first end and at the ground/sea-bed). As shown in FIG. 1, in some embodiments, anchor 170 includes anchor bridle 174 connected between fixed attachment 172 and another fixed attachment point (not shown). In some embodiments, fixed attachment 172 is also connected by another anchor bridle (not shown) to another fixed attachment point (not shown). In some embodiments, outer towers 108 and 114 are connected to anchor bridle 174 via 176a and 178a, respectively.

In some embodiments, four fixed attachments are interconnected by four anchor bridles. In some embodiments, six fixed attachments are interconnected by six anchor bridles. In some embodiments, the anchor bridles form a parabolic arc. As one of skill in the art will understand, the parabola may have different distances between the focus and vertex. The distance may be chosen so that downwind forces are distributed differently, depending on expected atmospheric conditions. In some embodiments, the anchor bridles take the shape of other conic sections. In some embodiments, the anchor bridles form a catenary shape. In some embodiments, the anchor bridles are connected to third anchor point to offset downwind forces. In some embodiments, the anchor is a suspension bridge shape (e.g., like the parabolic shapes described above). In some embodiments, the anchor is a cable-stayed bridge shape (e.g., forming a fan-like attachment to anchor attachment points). Some embodiments include combinations of suspension bridge and cable-stayed bridge shapes.

In some embodiments, buoyant devices (e.g., a flotation barge) are connected at the second end of some or all of the plurality of towers. The buoyant devices may allow apparatus 100 to float, such as on water. In some embodiments, the apparatus 100 floats in the water and captures power from the water (e.g., using hydrofoils) and/or from a different fluid (e.g., floating in water, capture power from air using airfoils). In some embodiments, apparatus 100 floats in water and captures power from the water. For example, the towers are extended downward into the water and power harvesting devices travel through the water. In some embodiments, the buoyancy devices have a buoyancy factor of 2-3.

In some embodiments, apparatus 100 floats in a fluid, and bridling system 150 balances forces in a third direction, in addition to the first and second directions. For example, if apparatus 100 is fitted with buoyant devices, then the towers may change position in the third direction and bridling system 150 may further serve to balance forces in the third direction. In some embodiments, the structure will come to a point of minimal potential energy—the buoyant devices will rise in the fluid (e.g., water) until the bridles are taught. For example, the towers may move up and down, depending on the forces created by the bridles. In some instances, at low winds, there may be less downwind force on the towers, and at high winds, more downwind force. The towers may advantageously change their height in the water to balance the force.

The buoyant devices can reach a highest floatation point, depending on bridle length. The whole structure may adjust accordingly to the highest floatation point, accounting for supported mass by each buoyant device. In some embodiment, bridling system 150 includes a second connection to the towers (e.g., bridles 152) that works with the first connection described above to distribute forces. In some embodiments, apparatus 100 is configured such that, when forces on the apparatus are balanced, the upper connection of bridling system 150 is positioned above the water-air interface (or another interface between two different fluids), and the second connection of bridling system 150 is positioned below the water-air interface (or another interface between two different fluids). In some instances, one tower may begin to sink (e.g., due to exogenous increased downward forces), and in response, bridling system 150 advantageously distributes the load to adjacent towers. Buoyancy system and bridling system 150 may thus operate to keep the towers in place. When used, the bridling system 150 toward the first end of the towers may keep the towers aligned, and thus, may reduce sinking and/or oscillation of the apparatus.

In some embodiments, apparatus 100 floats on a fluid, and the outer towers are connected to the anchor bridle 174 at a second point. For example, outer towers 108 and 114 are connected to anchor bridle 174 via 176b and 178b, respectively.

In some embodiments, the interconnections between towers are formed by ropes. In some embodiments, there are 11 ropes in the X direction and 11 in the Y direction (121 intersections). As discussed herein and as will be apparent to one skilled in the art, other numbers of ropes in the X direction, Y direction, and/or combinations of X direction and Y direction could be used.

In some embodiments, the bridling system 150 has a catenary shape. In some embodiments, the buoyancy of buoyant devices is varied to influence the catenary shape. For example, higher buoyancy buoyant devices on the perimeter (e.g., the outer towers) can contribute to a flatter shape for bridling system 150. This may allow towers of the same length to settle at a same height above the water-air interface (or another interface between two different fluids) (e.g., when apparatus 100 floats in water or another fluid).

In some embodiments, crosswind forces are held by connections to anchors. In some instances, the forces may pull the towers down. Advantageously, by only connecting the outer towers, only those towers have “angled” bridling (e.g., non-outer towers are interconnected parallel to the ground/sea-bed, so no downward force is exerted). In some embodiments, buoyant devices connected to the outer towers are more buoyant than the non-outer tower buoyant devices. Advantageously, this may reduce cost per tower as apparatus 100 scales in the X-Y plane.

In some embodiments, apparatus 100 includes controls (not shown), and the controls include: changing the aerodynamic profile (mount angle and rail speed) of an airfoil attached to a track, to instantaneously change downwind forces; “bunching up” airfoils to concentrate forces; changing buoyancy dynamically (e.g., with air pressure or a bilge pump); altering the length/tension in the components of bridling system 150 (e.g., an onboard electric winch at each connection point or an onboard electric turnbuckle); or altering the length/tension in the anchor bridle. In some embodiments, changing the angle of attack of an airfoil creates thrust, yielding an upwind force, which may be used to maneuver apparatus 100 on a surface of water (or another fluid) or control oscillations of apparatus 100. In some embodiments, changing the roll angle of the airfoil can control Z direction forces on apparatus 100, which can be combined with forces generated by the buoyant devices to control a vertical position of a tower(s) of apparatus 100. In some embodiments, changing the roll angle of the airfoil advantageously facilitates an airborne apparatus 100.

In some embodiments, the apparatus 100 is configured to float, and a submerged target depth can be preset for each buoyant device. In some examples, the submerged depth is below a low tide line, and below turbulence caused by wave action. For example, the buoyant devices may be 20 feet below sea level, and a power harvesting device (e.g., a track) begins at 50 feet above sea level and extending upward. In some embodiments, an ocean depth on which apparatus 100 floats is 200 feet or more.

In some embodiments, the apparatus includes controls to alleviate adverse weather effects, such as hurricanes. For instance, such controls include sinking a part or the whole structure (e.g., reduce buoyancy, reel in the bridling system, and wait out the storm).

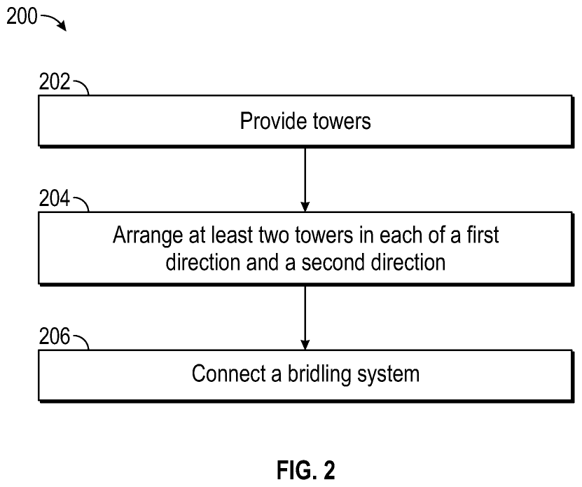

FIG. 2 illustrates an exemplary method 200 of an exemplary apparatus, according to embodiments of the disclosure. In some embodiments, the method 200 is performed with respect to apparatus 100. Although the method 200 is illustrated as including the described steps, it is understood that different order of step, additional step (e.g., combination with other methods disclosed herein), or less step may be included without departing from the scope of the disclosure. For the sake of brevity, some elements and advantages associated with apparatus 100 are not repeated here.

In some embodiments, the method 200 includes providing a plurality of towers (step 202). For example, the method 200 may provide two or more towers described with respect to FIGS. 1A and 1B.

In some embodiments, the method 200 includes arranging at least two towers in each of a first direction and a second direction, each tower having a first end above a second end in a third direction (step 204). For example, as described with respect to FIGS. 1A and 1B, the disclosed towers are arranged along the X and Y directions, and the towers have a first end above a second end along the Z direction.

In some embodiments, the method 200 includes connecting a bridling system from each of the plurality of towers to other towers of the plurality of towers, the bridling system connected to each tower above the second end of the respective tower and balancing forces on each tower in the first and second directions (step 206). For example, as described with respect to FIGS. 1A and 1B, the bridling system 150 connects the disclosed towers above a second end of a respective tower. The bridling system 150 balances forces on each tower in the X and Y directions.

In some embodiments, the method 200 includes connecting the bridling system to each tower at two points above the second end of the respective tower. For example, as described with respect to FIGS. 1A and 1B, the bridling system 150 connects to each disclosed towers at two points above the second end of the respective tower.

In some embodiments, the method 200 includes connecting the bridling system to each tower at two points on the respective tower. For example, as described with respect to FIGS. 1A and 1B, the bridling system 150 connects to a respective disclosed towers at two points.

In some embodiments, the method 200 includes providing a track having first and second sections coupled to the towers of the plurality of towers; connecting a terminal to the first and second sections; coupling an airfoil to the track, wherein the airfoil is moveable in opposite directions when alternately coupled to the first section and second section; and harvesting power from a fluid through the movement of the airfoil.

For example, as described with respect to FIGS. 1A and 1B, a track having sections 160a and 160b is provided, and the track is coupled to the towers. The sections are connected to a terminal 160c, and an airfoil 160d is coupled to the track. The airfoil 160d is moveable in opposite directions when alternately coupled to the first section 160a and second section 160b. Power may be harvested from a fluid (e.g., wind) through the movement of the airfoil 160d.

In some embodiments, the method 200 includes connecting a plurality of buoyant devices at the second end of each of a respective one of the plurality of towers. For example, as described with respect to FIGS. 1A and 1B, a plurality of buoyant devices is connected at the second end of each of the plurality of the disclosed towers. In some embodiments, the method 200 includes positioning the buoyant devices below a water-air interface. For example, as described with respect to FIGS. 1A and 1B, the buoyant devices of the apparatus 100 are positioned below a water-air interface.

In some embodiments, the method 200 includes positioning a first part of the bridling system above the water-air interface and a second part of the bridling system below the water-air interface. For example, as described with respect to FIGS. 1A and 1B, a first part of the bridling system 150 is positioned above the water-air interface, and a second part of the bridling system 150 is positioned below the water-air interface.

In some embodiments, the method 200 includes positioning an anchor below the water-air interface; and coupling outer towers of the plurality of towers above the water-air interface to the anchor. For example, as described with respect to FIGS. 1A and 1B, the anchor 170 is positioned below the water-air interface, and outer towers are coupled above the water-air interface to the anchor 170.

In some embodiments, the method 200 includes positioning an anchor; and coupling outer towers of the plurality of towers to the anchor. For example, as described with respect to FIGS. 1A and 1B, the anchor 170 is positioned, and outer towers are coupled to the anchor 170.

In some embodiments, the method 200 includes connecting multiple anchor points to two other anchor points by an anchor bridle; and connecting the each outer tower of the plurality of towers to the anchor bridle. For example, as described with respect to FIGS. 1A and 1B, for the apparatus 100, multiple anchor points are connected to two other anchor points by an anchor bridle 174.

In some embodiments, an exemplary method of installation includes putting a buoyant device (e.g., a donut shaped buoyant device) at a base of a tower and another buoyant device at a top of a tower. In some embodiments, both buoyant devices are deflated.

In some embodiments, the method includes laying towers down flat on a floating barge (e.g., a 300 foot long floating barge). In some embodiments, the method includes taking the barge to an installation site. In some embodiments, the method includes inflating the buoyant devices. In some embodiments, the method includes rolling a tower into the ocean. In some embodiments, the method includes attaching the bridling system to two points on a tower. In some embodiments, some or all of these steps are repeated for some or all of the remaining towers of the apparatus.

In some embodiments, maneuver of the apparatus is coordinated. In some embodiments, a method of coordinating maneuver of the apparatus includes deflating a bottom buoyant device and adjusting a rope length of the bridling system. In some instances, the base of each tower may sink. The buoyancy of the top buoyant device keeps the top of the apparatus afloat, and each tower may “stand up” and be submerged. In some embodiments, the method includes tightening an upper portion of the bridling system (e.g., an upper portion of the bridling system 150). This step advantageously causes the structure to have balanced forces in an X-Y plane. In some embodiments, the method includes inflating bottom buoyant devices. In some instances, in response, the structure rises out of the water (or a different fluid) in an upright position. In some embodiments, the top buoyant devices is also deflated.

In some embodiments, tracks are assembled at water level and winched up. In some embodiments, airfoils run up to the track via a side track and a “railroad switch”.

In some embodiments, each tower is a round tube 300 feet long (approx. 92 meters), 16-24 inch in diameter. In some embodiments, each wing has 15 meter wingspan and 1.875 meter chord. In some embodiments, each tower is coupled to three tracks, stacked above each other. In some embodiments, each tower extends 7 meters below the waterline, and 85 meters above. For example, if the apparatus is designed to operate in waves up to 10 meters, the bottom of the bottom rail may be at 17.5 meters, and the top of the top rail may be at 71.5 meters. In some embodiments, each tower is spaced 180 meters apart, and a suspension rope (e.g., a bridle of the bridle system 150) sags (e.g., 7.5%, 13.5 meters, in a catenary shape, in a parabolic shape) between adjacent towers. In some embodiments, each tower may cover an effective swept area of 16,200 square meters (e.g., 15 meter wingspan×180 meters tower separation×2 rails per track×3 tracks). For example, at a power density of 325 watts per square meter, 5.26 MW per tower can be realized. In some embodiments, each airfoil has a notional capacity of 300 kW, and there is a separation of 50 meters between each wing.

In some embodiments, each row of the array is separated by six to ten diameters (e.g., a spacing between sections of the track) of a track. In some embodiments, each row of the array is separated by six diameters of a track. If a diameter is wingspan×2×number of tracks, then spacing between rows is 540 meters. As will be readily understood by one of skill in the art, inter-row spacing of towers can vary to suit particular design requirements. The closer spacing of the intra-row towers may help manage the “sag” of suspension ropes, if necessary. In some embodiments, inner towers and bridle structures are anchored. In some embodiments, the anchored inner towers and/or bridle structures may be used in lieu of or in addition to anchoring of outer towers. This may be particularly advantageous for large inter-row spacing, where the sag may be excessive; in some instance, the sag may exceeding tower height.

In some embodiments, attachment points 172 may not be fixed. In some embodiments, three or more fixed anchor points are created more distant from apparatus 100 (not shown). In some embodiments, two or more connections are made from each attachment point 172 to the distant anchor points. Thus, in some embodiments, attachment points 172 are located in different positions, due to the buoyancy of the device and variable length of the connections. For example, for a given buoyancy and length of connections between attachment points, apparatus 100 is at first position. By changing the length of the connections between attachment points and the distant anchors, the location of each attachment point can be changed, relative to a particular XYZ coordinate. By coordination changing of these connection lengths accordingly, an entire structure apparatus 100 may be caused to rotate around a Z axis and move to a second location. In this way, the structure can advantageously match a direction of flow of an oncoming fluid.

In one aspect, an apparatus includes: a plurality of towers comprising at least two towers arranged in each of a first direction and a second direction, each tower having a first end above a second end in a third direction; and a bridling system connecting each of the plurality of towers to other towers of the plurality of towers, the bridling system connected to each tower above the second end of the respective tower and balancing forces on each tower in the first and second directions.

In some aspects of the above apparatus, the apparatus further includes: a track having first and second sections coupled to towers of the plurality of towers; a terminal connecting the first and second sections; an airfoil moveable in opposite directions when alternately coupled to the first section and second section; and a power generator to harvest power from a fluid through the movement of the airfoil.

In some aspects of the above apparatuses, the apparatus further includes a plurality of buoyant devices, each connected at the second end of a respective one of the plurality of towers.

In some aspects of the above apparatuses, the apparatus is configured such that the buoyant devices are positioned below a water-air interface when the bridling system balances the forces on the towers.

In some aspects of the above apparatuses, the bridling system is connected to each tower at two points above the second end of the respective tower.

In some aspects of the above apparatuses, the apparatus is configured such that, when forces on the apparatus are balanced, a first part of the bridling system is positioned above the water-air interface and a second part of the bridling system is positioned below the water-air interface.

In some aspects of the above apparatuses, the apparatus further includes an anchor positioned below a water-air interface, wherein each outer tower of the plurality of towers is coupled above the water-air interface to the anchor.

In some aspects of the above apparatuses, the apparatus further includes an anchor, wherein each outer tower of the plurality of towers is coupled to the anchor.

In some aspects of the above apparatuses, the anchor includes multiple anchor points, each connected to two other anchor points by an anchor bridle, and the each outer tower of the plurality of towers is connected to the anchor bridle.

In some aspects of the above apparatuses, the bridling system is connected to each tower at two points on the respective tower.

In one aspect, a method includes: providing a plurality of towers; arranging at least two towers in each of a first direction and a second direction, each tower having a first end above a second end in a third direction; and connecting a bridling system from each of the plurality of towers to other towers of the plurality of towers, the bridling system connected to each tower above the second end of the respective tower and balancing forces on each tower in the first and second directions.

In some aspects of the above method, the method further includes: providing a track having first and second sections coupled to the towers of the plurality of towers; connecting a terminal to the first and second sections; coupling an airfoil to the track, wherein the airfoil is moveable in opposite directions when alternately coupled to the first section and second section; and harvesting power from a fluid through the movement of the airfoil.

In some aspects of the above methods, the method further includes: connecting a plurality of buoyant devices at the second end of each of a respective one of the plurality of towers.

In some aspects of the above methods, the method further includes positioning the buoyant devices below a water-air interface.

In some aspects of the above methods, the method further includes connecting the bridling system to each tower at two points above the second end of the respective tower.

In some aspects of the above methods, the method further includes positioning a first part of the bridling system above the water-air interface and a second part of the bridling system below the water-air interface.

In some aspects of the above methods, the method further includes: positioning an anchor below the water-air interface; and coupling outer towers of the plurality of towers above the water-air interface to the anchor.

In some aspects of the above methods, the method further includes: positioning an anchor; and coupling outer towers of the plurality of towers to the anchor.

In some aspects of the above methods, the method further includes: connecting multiple anchor points to two other anchor points by an anchor bridle; and connecting the each outer tower of the plurality of towers to the anchor bridle.

In some aspects of the above methods, the method further includes connecting the bridling system to each tower at two points on the respective tower.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt to a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other several embodiments without departing from the scope or spirit of the various embodiments. Moreover, use of terms such as first, second, third, etc., do not necessarily denote any ordering or importance, but rather are used to distinguish one element from another.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The use herein of “including,” “comprising,” “having,” “containing,” “involving,” and variations thereof is meant to encompass the items listed thereafter and equivalents thereof as well as additional items and do not preclude the presence or addition of one or more other features, integers, processes, operations, elements, components, and/or groups thereof. As used herein, the singular forms “a”, “an” and “the” are intended to include the plural forms as well, unless the context clearly indicates otherwise.

1. An apparatus comprising:
a plurality of towers comprising at least two towers arranged in each of a first direction and a second direction, each tower having a first end above a second end in a third direction; and
a bridling system connecting each of the plurality of towers to other towers of the plurality of towers, the bridling system connected to each tower above the second end of the respective tower and balancing forces on each tower in the first and second directions.

2. The apparatus of claim 1, further comprising:
a track having first and second sections coupled to towers of the plurality of towers;
a terminal connecting the first and second sections;
an airfoil moveable in opposite directions when alternately coupled to the first section and second section; and
a power generator to harvest power from a fluid through the movement of the airfoil.

3. The apparatus of claim 1, further comprising:
a plurality of buoyant devices, each connected at the second end of a respective one of the plurality of towers.

4. The apparatus of claim 3, wherein the apparatus is configured such that the buoyant devices are positioned below a water-air interface when the bridling system balances the forces on the towers.

5. The apparatus of claim 3, wherein the bridling system is connected to each tower at two points above the second end of the respective tower.

6. The apparatus of claim 5, wherein the apparatus is configured such that, when forces on the apparatus are balanced, a first part of the bridling system is positioned above the water-air interface and a second part of the bridling system is positioned below the water-air interface.

7. The apparatus of claim 1, further comprising an anchor positioned below a water-air interface, wherein each outer tower of the plurality of towers is coupled above the water-air interface to the anchor.

8. The apparatus claim 1, further comprising an anchor, wherein each outer tower of the plurality of towers is coupled to the anchor.

9. The apparatus of claim 8, wherein:
the anchor comprises multiple anchor points, each connected to two other anchor points by an anchor bridle, and wherein:
the each outer tower of the plurality of towers is connected to the anchor bridle.

10. The apparatus of claim 1, wherein the bridling system is connected to each tower at two points on the respective tower.

11. A method comprising:
providing a plurality of towers;
arranging at least two towers in each of a first direction and a second direction, each tower having a first end above a second end in a third direction; and
connecting a bridling system from each of the plurality of towers to other towers of the plurality of towers, the bridling system connected to each tower above the second end of the respective tower and balancing forces on each tower in the first and second directions.

12. The method of claim 11, further comprising:
providing a track having first and second sections coupled to the towers of the plurality of towers;
connecting a terminal to the first and second sections;
coupling an airfoil to the track, wherein the airfoil is moveable in opposite directions when alternately coupled to the first section and second section; and
harvesting power from a fluid through the movement of the airfoil.

13. The method of claim 11, further comprising:
connecting a plurality of buoyant devices at the second end of each of a respective one of the plurality of towers.

14. The method of claim 13, further comprising positioning the buoyant devices below a water-air interface.

15. The method of claim 13, further comprising connecting the bridling system to each tower at two points above the second end of the respective tower.

16. The method of claim 15, further comprising positioning a first part of the bridling system above the water-air interface and a second part of the bridling system below the water-air interface.

17. The method of claim 11, further comprising:
positioning an anchor below the water-air interface; and
coupling outer towers of the plurality of towers above the water-air interface to the anchor.

18. The method of claim 11, further comprising:
positioning an anchor; and
coupling outer towers of the plurality of towers to the anchor.

19. The method of claim 18, further comprising
connecting multiple anchor points to two other anchor points by an anchor bridle; and
connecting the each outer tower of the plurality of towers to the anchor bridle.

20. The method of claim 11, further comprising connecting the bridling system to each tower at two points on the respective tower.
